(19) United States
(12) Patent Application Publication
(10) Pub. No.: US 2006/0091848 A1
(43) Pub. Date: May 4, 2006

(54) Method and device for determining battery status

(75) Inventors: Harald Braun, Esslingen (DE); Christof Gross, Weinstadt-Strumpfelbach (DE); Franz Nietfeld, Esslingen (DE); Liane Schupp, Esslingen (DE)

Correspondence Address: FITCH, EVEN, TABIN & FLANNERY, P. O. BOX 65973, WASHINGTON, DC, 20035, US

(73) Assignee: DaimlerChrysler, Stuttgart (DE)

(21) Appl. No.: 10/537,769

(22) PCT Filed: Nov. 5, 2003
(86) PCT No.: PCT/EP03/12300

§ 371 Date: Jul. 20, 2005

(30) Foreign Application Priority Data
Dec. 4, 2002 (DE) 102 56 588.0

(51) Int. Cl. H02J 7/00

(52) U.S. Cl. 320/104

(57) ABSTRACT

The invention relates to a method and an apparatus for battery state identification. The battery state is determined by measurement of the voltage of a motor vehicle battery during the starting process over a predetermined time period, determination of a minimum voltage level of the motor vehicle battery during the predetermined time period of the measurement process, assessment of the state of charge of the vehicle battery on the basis of the minimum voltage level, and control of the generator as a function of the assessment of the state of charge of the motor vehicle battery, thus ensuring an adequate supply to the vehicle power supply system and adequate charging of the vehicle battery, while at the same time optimizing the fuel consumption and the emissions. The generator is driven as a function of the determined state of charge and, optionally, the ambient temperature, by predetermining either a nominal value of the charging voltage at the normal charging level, a nominal value of the charging voltage for engine load reduction, a nominal value of the charging voltage at a reduced vehicle power supply system level, or a nominal value of the charging voltage at the recuperation level.

The invention relates to a method and an apparatus for battery state identification.

Various approaches for assessment and analysis of the starter battery in a vehicle are conventionally known. These are used to ensure that the battery has an adequate state of charge, and generally use an expensive current sensor, which is susceptible to faults and errors.

EP 0 071 816 A1 discloses a method and an apparatus for measuring the state of charge of a motor vehicle battery, in which the battery voltage is measured on load. During the engine starting process, the battery is loaded with the starter current. During this time phase (for about 10 seconds), the battery voltage is measured, and is supplied to an evaluation circuit. The evaluation circuit generates a current pulse, with a constant amplitude, whose length is a function of the battery terminal voltage. The current pulse is passed to a storage component, which stores the amount of charge. Furthermore, a shunt resistance measures charging and discharge currents which occur while the battery is being loaded, which are supplied with the correct mathematical sign to the storage component. Addition of the stored currents results in a control signal which, if a specific limit value is undershot, operates a switching element for automatic starting and stopping of the vehicle and/or a visual display apparatus (LED) for the user in order to inform the user of the state of charge of his battery.

However, one problem is that, when starting in the morning, for example after a cold winter night, the starting current is significantly higher, so that the terminal voltage is very much lower, thus resulting in the limiting starting voltage being reached or virtually reached as a result of the morning start. In this case, the start of charge can be defined reliably only once the vehicle has already been driven for some time and the engine has assumed a specific operating temperature, so that a relatively steady state is reached.

Furthermore, DE 41 06 725 A1 proposes a circuit arrangement for indicating the state of charge of a rechargeable battery, in which the state of charge of the battery is determined by integration of the current flowing in the load circuit. Reproducible accuracy can be achieved for the state of charge by taking into account various correction factors, such as the switch-on current surge, the temperature, the offset and the self-discharge of the battery. A difference from at least one limit value of the battery voltage can be output on a display as the state of charge of the battery.

However, this state of charge assessment requires an expensive current sensor, which is susceptible to faults and errors.

One object of the present invention is thus to provide a method and an apparatus for battery state identification, which do not require a current sensor that is susceptible to faults and which allows a reliable assessment of the state of charge irrespective of the temperature and time for which the vehicle has been operated.

According to the invention, this object is achieved by a method having the features as claimed in claim 1, and by an apparatus having the features as claimed in claim 13. Advantageous developments of the invention are specified in the dependent claims.

The lack of the current sensor according to the invention allows simple and cost-effective battery state identification which, in addition, makes use of the drive for the generator for improved charging of the battery and for measures for optimization of the consumption and emissions of the overall vehicle. Furthermore, the battery state identification according to the invention is able (since the temperature can optionally be used as an additional assessment parameter) to make a reliable assessment, without any incorrect assessments resulting from very low temperatures.

These and further objects, features and advantages of the present invention will become evident from the following description of one preferred exemplary embodiment in conjunction with the drawing, in which:

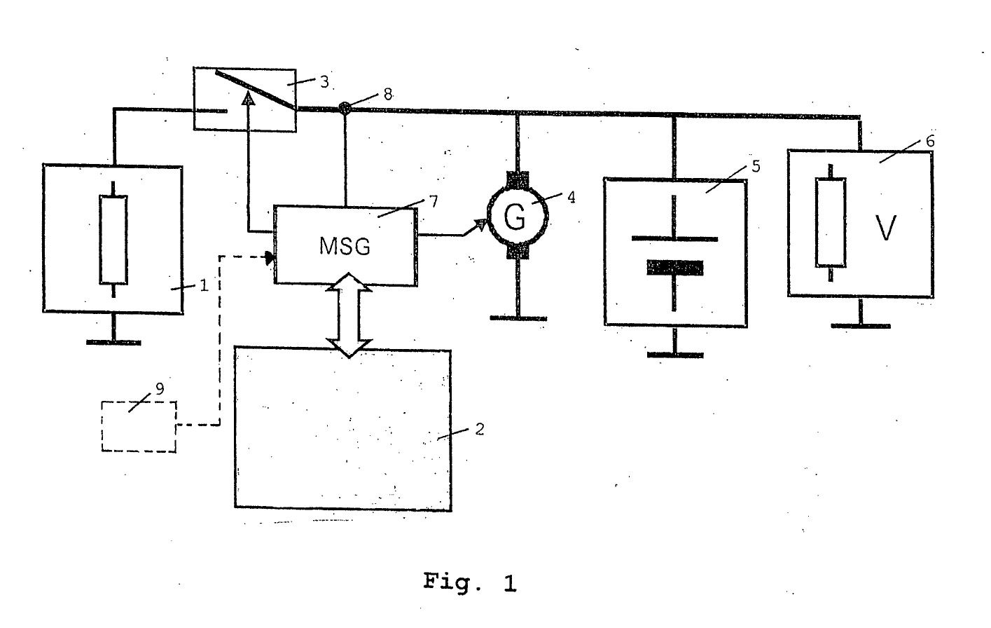

FIG. 1 shows a block diagram of a basic vehicle power supply system structure according to the invention,

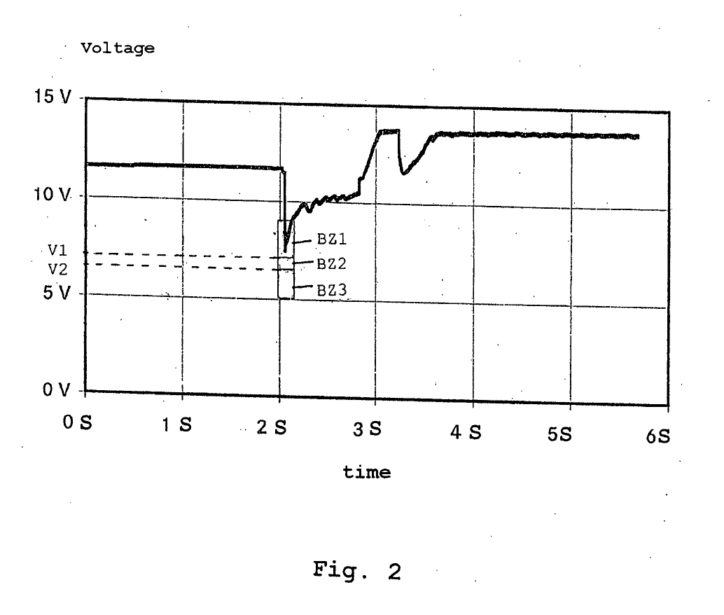

FIG. 2 shows a voltage profile during starting, including various state of charge assessments,

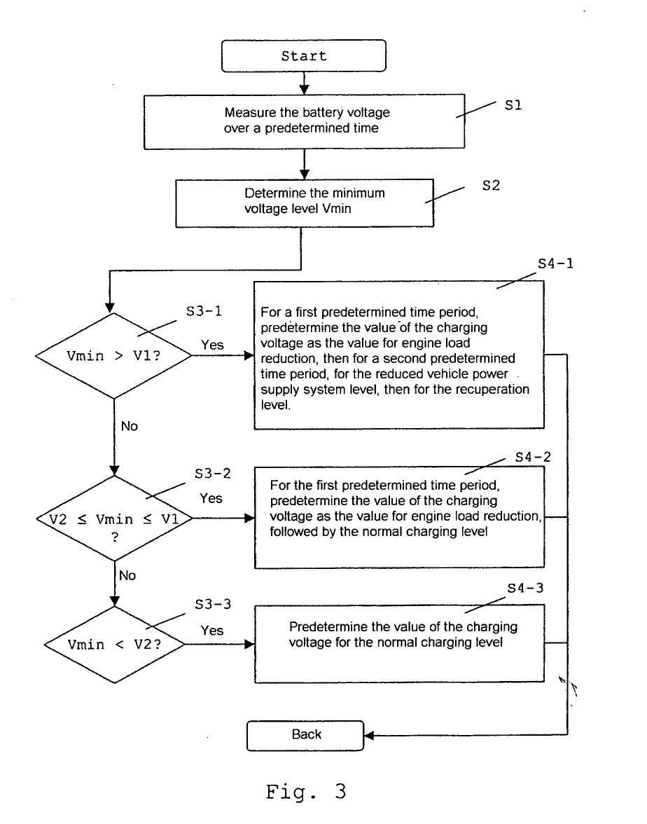

FIG. 3 shows a flowchart of the method according to the invention for battery state identification, and

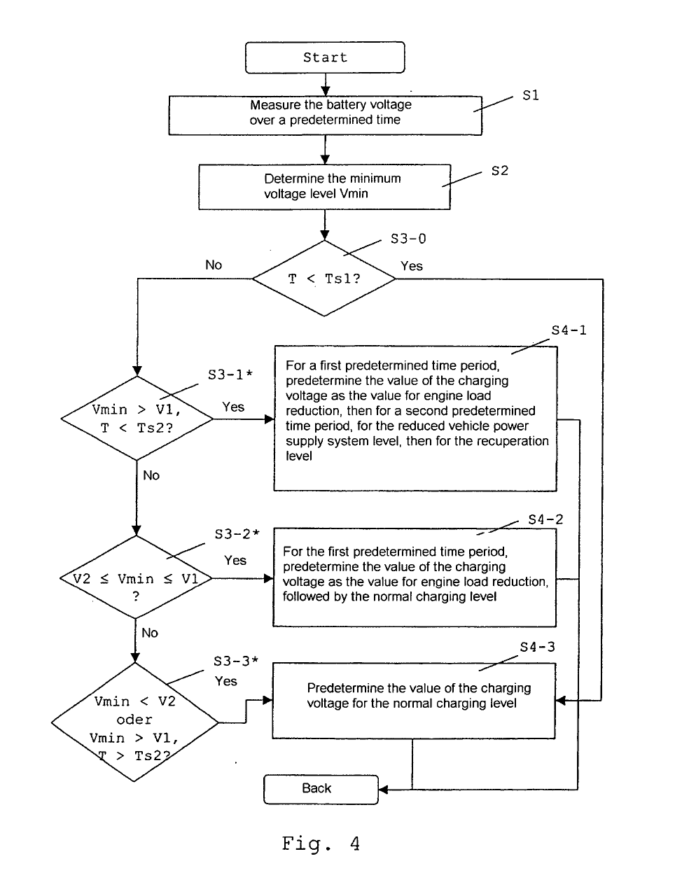

FIG. 4 shows a flowchart of a modification of the method according to the invention for battery state identification.

According to the invention, a simple solution based on voltage measurement is used to achieve fuel savings and emission reductions by the entire electrical power requirement for the vehicle power supply system and the battery being produced by the generator when the internal combustion engine is operating with optimized consumption and emissions and the battery state of charge is adequate. In this case, the conventional current detection is dispensed with. On the basis of the high-frequency detection of the voltage and implicitly stored information about the vehicle, the battery state is assessed according to the invention on the basis of the voltage response in defined situations, for example during starting, when defined loads are switched on briefly during operation, when the generator is switched off briefly, etc. and this is used as the basis for deriving various open-loop and closed-loop control strategies, optimized with regard to consumption and emissions, for the generator, which are adopted while driving.

FIG. 1 shows a block diagram of the basic vehicle power supply system structure according to the invention. In this case, the reference number 1 denotes a load (SLP), 2 an internal combustion engine, 3 a switching device, 4 a generator, 5 a (vehicle) battery, 6 a vehicle power supply system, 7 an engine controller (MSG) and 8 a voltage measurement device. The switching device 3 is switched via an actuator which is contained (not shown) in the engine controller 7. The measurement signal for the voltage measurement device 8 is passed to the engine controller 7, which emits control signals for the generator 4.

Furthermore, an optional temperature measurement device 9, which is represented by dashed lines, is provided in order to measure the outside temperature, and its output signals are likewise supplied to the engine controller 7. Alternatively, the output signal from a temperature measurement device which is already provided in the vehicle and, is for example, a component of the air-conditioning system, can also be supplied to the engine controller 7.

The engine controller 7 has a device for determining the minimum level of the voltage signal which is supplied from the voltage measurement device 8 over a predetermined time period, as well as a device for assessment of the state of charge of the vehicle battery 5 on the basis of the minimum voltage level determined by the device for determining the minimum level. The device for assessment of the state of charge uses the determined minimum level during the measurement time period to assess the depth of the voltage dip in comparison to the output voltage which was present, for example, before a starting process. The voltage range in which such a dip in the voltage level can occur is subdivided into at least two, and preferably into three, voltage ranges, in which the state of charge of the battery is assessed as “very powerful” (BZ1) for a very low voltage dip, “powerful” (BZ2) for a greater voltage dip, but with which, for example, the cold starting capability is still ensured, and “restricted power” (BZ3) for a very large voltage dip for which, for example, a (further) cold start is no longer possible without restrictions. FIG. 2 shows a voltage profile during starting, including various state of charge assessments.

During cold starting, the vehicle conditions are approximately constant, but a level dip always occurs during the starting process. The depth of the level dip is affected, inter alia, not only by the battery state of charge but also the battery age and the ambient temperature.

Depending on this state of charge as determined by the device for assessment of the state of charge, that is to say “very powerful” (BZ1), “powerful” (BZ2) or “restricted power” (BZ3) in its own right or in conjunction with a further parameter, for example the temperature, various measures are taken—grouped into measurement packets—in order to achieve optimum battery charging and optimized consumption and emission levels. For this purpose, a device for controlling the generator presets for the generator 4 a nominal value (which is in each case associated with the assessed state of charge) for the charging voltage and its time period, in which case this nominal value may be either a normal charge level, a nominal value for engine load reduction, a reduced vehicle power supply system level or a recuperation level, depending on how good or bad the state of charge has been assessed to be, that is to say whether or not there is any need to charge the vehicle battery. The precise association between the respective nominal values and the assessed states of charge will be described in more detail in the following explanation of the method according to the invention. This explanation is not given here, in order to avoid repetition.

The method according to the invention for battery state identification will now be described in more detail with reference to FIG. 3. In the method according to the invention for battery state identification for a motor vehicle, a voltage of a battery 5 is first of all measured over a predetermined time period by a voltage measurement device 8 in step 1. This predetermined time period may, for example, be 5 seconds or more. The output signal from the voltage measurement device over a predetermined time period is used, in step 2, to determine a minimum voltage level of the battery 5, by means of a device, which is not shown but is contained in the engine controller, for determination of a minimum level. This minimum voltage level is then assessed in step 3, with the steps S3-S1 to S3-S3, by means of a device, which is likewise contained in the engine controller 7, for assessment of the state of charge of the battery 5, with the state of charge being assessed as “very powerful” (BZ1) (step S3-1) if a minimum voltage level is above a first threshold value V1, being assessed as “powerful” (BZ2) (step S3-2) between the first threshold value V1 and a second threshold value V2, which is lower than the first threshold value V1, and being assessed as “restricted power” (BZ3) (step S3-3) below the second threshold value V2. This assessment result is then passed to the engine controller 7, which matches the drive for the generator 4 in step 4 as appropriate for the result of the assessment of the state of charge. In this case, the first threshold value V1 may, for example, be between about 7 and 8 V, and the second threshold value V2 may, for example, be between about 6 and 7 V.

In the present exemplary embodiment of the invention, the generator 4 is now driven by the engine controller 7 as a function of the assessment result of the state of charge by the device for assessment of the state of charge as follows:

Step S4-3:

If the battery state has been assessed as restricted power (BZ3), the nominal value of the charging voltage is set to a normal charging level for an unlimited time. In this case, it is not possible to save any fuel or emissions, since the primary factor is that the state of charge of the battery 5 must be improved in order to ensure problem-free and reliable operation of the vehicle.

Step S4-2:

If the state of charge has been assessed as powerful (BZ2), the nominal value of the charging voltage is set to a value for engine load reduction for a limited time, and is then to set to the normal charging level. This limited time period is a dead time. In this way, the good state of charge of the battery is used in order to reduce the power demand on the vehicle for as long as this is possible without adversely affecting the performance of the battery, and thus to reduce the fuel consumption and the emissions.

Step S4-1:

If the state of charge has been assessed as very powerful (BZ1), the nominal value of the charging voltage, for example 12V, is fixed by voltage monitoring at the value for engine load reduction, and then at a reduced vehicle power supply system level, for example 12V for a time period which is governed by the battery being used, and then at a recuperation level, for example 15V.

This means that the state of charge that is assessed as very powerful (BZ1) can be used for consumption and emission reduction, since the total electrical power demand is reduced since there is no need to recharge the battery.

The method for battery state identification according to the invention can thus be used in a simple manner to identify the battery state and to drive the generator appropriately, so that the fuel consumption and emissions can be considerably reduced.

In a development of the exemplary embodiment described above of the method according to the invention, which will be described in the following text and is illustrated in FIG. 4, the outside temperature is used as a further parameter, thus allowing further optimization of the consumption and of the emissions, as well as even better assessment of the state of charge. By way of example, in the described development of the above exemplary embodiment, a distinction is drawn between three temperature ranges T1 to T3, which are defined by two temperature threshold values Ts1 and Ts2, in which case, for example, Ts1=0° C. and Ts2=25° C., so that T1: T<Ts1, T2: Ts1 ? T<Ts2 and T3: Ts2 ? T.

Fundamentally, the steps 1 to 4 described above are likewise carried out in the development of the method according to the invention for battery state identification. However, the assessment of the state of charge that is carried out in step 3 and the matching of the drive of the generator 4 that is carried out by the engine controller 7 are modified.

The modified drive for the generator 4 according to the development of the invention is carried out as a function of the assessment result of the state of charge, and of the detected temperature, as follows:
1) If the measured temperature T is in the temperature range T1, that is to say below the first temperature threshold value Ts1 (step S3-0) and in the temperature ranges T2 and T3 (that is to say when the temperature T is greater than the first temperature threshold value Ts1), the nominal value of the charging voltage is set (step S4-3) to a normal charging level for an unlimited time, irrespective of the battery state, for restricted performance of the battery (BZ3) (step S3-3*).
In this case, no fuel or emission saving is possible, since a better vehicle battery state of charge must be produced again.
2) If the measured temperature T is above the first temperature threshold value Ts1 (step S3-0) and the state of charge has been assessed as powerful (BZ2) (step S3-2*), the nominal value of the charging voltage is set to a value for engine load reduction for a limited time (for example until a minimum voltage is undershot), and is then set to the normal charging level (step S4-2).
3) If the measured temperature T is between the first temperature threshold value Ts1 (step S3-0) and the second temperature threshold value Ts2 and the state of charge has been assessed as very powerful (BZ1) (step S3-1*), the nominal value of the charging voltage is set to the value for engine load reduction for a limited time (for example until a minimum voltage is undershot), and is then set to a reduced vehicle power supply system level (for example 13V), and then to a recuperation level (for example 15V) (step S4-1).
In this way, the state of charge which has been assessed as very powerful (BZ1) can be used for consumption and emission reduction, since the total electrical power demand is reduced owing to the lack of any need to recharge the battery.
4) If the temperature T is above the second temperature threshold value Ts2 and the state of charge has been assessed as very powerful (BZ1) (step S3-3*), the nominal value of the charging voltage is set to the normal charging level for an unlimited time (step S4-3).

An additional step S5, in which the assessment result is displayed visually to the user, can optionally be included both in the method as shown in FIG. 3 and in the method as shown in FIG. 4. When using three state of charge ranges, for example, this can be achieved in the form of traffic light colors, with green representing the optimum “very powerful” state, and red representing the worst state of charge “restricted power”. In this case, a display device (not shown), for example in the form of three differently colored LEDs (green, yellow, red) can be added to the apparatus according to the invention as shown in FIG. 1, to which the result from the device (7) for assessment of the state of charge is supplied for indication. Other indication and/or display types and devices for this information may, of course, also be used.

The method according to the invention for battery state identification, as well as the associated apparatus for battery state identification, thus make it possible to reduce the fuel consumption and the emissions as a function of the battery state of charge, and nevertheless to ensure an adequate battery state of charge at all times.

In summary, the invention discloses a method and an apparatus for battery state identification. The battery state is determined by measurement of the voltage of a motor vehicle battery during a starting process over a predetermined time period, determination of a minimum voltage level of the motor vehicle battery during the predetermined time period of the measurement process, assessment of the state of charge of the vehicle battery on the basis of the minimum voltage level, and control of the generator as a function of the assessment of the state of charge of the vehicle battery, thus ensuring an adequate supply to the vehicle power supply system and adequate charging of the vehicle battery, while at the same time optimizing the fuel consumption and the emissions. The generator is driven as a function of the determined state of charge and, optionally, the ambient temperature, by predetermining either a nominal value of the charging voltage at the normal charging level, a nominal value of the charging voltage for engine load reduction, a nominal value of the charging voltage at a reduced vehicle power supply system level, or a nominal value of the charging voltage at the recuperation level.

1. A method for battery state identification for a motor vehicle, having the following steps:
(S1) measurement of a voltage of a motor vehicle battery (5) during the starting process of a motor vehicle over a predetermined time period,
(S2) determination of a minimum voltage level of the motor vehicle battery (5) during the predetermined time period of the measurement process,
(S3-1 to S3-3; S3-0 to S3-3*) assessment of a state of charge of the motor vehicle battery (5) on the basis of the determined minimum voltage level,
(S4-1 to S4-3) control of a generator as a function of the assessment of the state of charge of the motor vehicle battery (5), so as to ensure an adequate supply for the vehicle power supply system and adequate charging of the motor vehicle battery (5), while at the same time optimizing the fuel consumption and the emissions.

2. The method as claimed in claim 1, characterized in that
(S5) the result of the assessment is output to a vehicle user.

3. The method as claimed in claim 1, characterized in that
the assessment of the state of charge in steps S3-1 to S3-3 is carried out by association of the minimum voltage level with one of at least two predetermined state of charge ranges.

4. The method as claimed in claim 3, characterized in that three predetermined state of charge ranges (BZ1, BZ2, BZ3) are formed, and are defined by two threshold values (V1, V2).

5. The method as claimed in claim 3, characterized in that the three predetermined state of charge ranges are the “very powerful” (BZ1), “powerful” (BZ2) and “restricted power” (BZ3) states of charge.

6. The method as claimed in one of claim 2, characterized in that
the result of the assessment in step S5 is output visually.

7. The method as claimed in claim 5, characterized in that
(S5) the result of the assessment is output to a vehicle user, and
the result of the assessment in step S5 is produced visually in the form of different colors for the three states of charge “restricted power” (BZ3), “powerful” (BZ2) and “very powerful” (BZ1).

8. The method as claimed in one of claim 1, characterized in that,
in step S4-3, a nominal value of the charging voltage is predetermined for a normal charging level for an unlimited time for the generator (4) for a state of charge is “restricted power” (BZ3),
in step S4-2, a nominal value of the charge voltage for engine load reduction, followed by the nominal value of the charging voltage for the normal charging level are predetermined for a predetermined time period for the generator (4) for a “powerful” (BZ2) state of charge,
in step S4-1, the nominal value of the charging voltage is predetermined for the value for engine load reduction, followed by a reduced vehicle power supply system level and then a recuperation level over a predetermined time period for the generator (4) for a “very powerful” (BZ1) state of charge.

9. The method as claimed in claim 1, characterized in that,
in steps S4-1 to S4-3, the generator is controlled as a function of the assessment of the state of charge of the motor vehicle battery (5) and of at least one further parameter in the steps S3-0 to S3-3*, in order to ensure adequate charging of the motor vehicle battery (5), and at the same time to optimize the fuel consumption and the emissions.

10. The method as claimed in claim 9, characterized in that the at least one further parameter is the ambient temperature (T).

11. The method as claimed in claim 10, characterized in that,
in step S4-3, a nominal value for the charging voltage for the normal charge level is predetermined for an unlimited time, irrespective of the temperature, for the generator (4) irrespective of the assessed state of charge for a temperature below a first temperature threshold value (Ts1) (step S3-0) and for a “restricted power” (BZ3) state of charge (step S3-1*),
in step S4-2, a nominal value of the charging voltage for engine load reduction, followed by the nominal value of the charging voltage for the normal charge level are predetermined over a predetermined time period for the generator (4) for a “powerful” (BZ2) state of charge (step S3-2*) and a temperature above the first temperature threshold value (Ts1) (step S3-0),
in step S4-1 the nominal value of the charging voltage for engine load reduction is predetermined for a predetermined time period, after which a nominal value of the charging voltage for a reduced vehicle power supply system level, followed by a nominal value of the charging voltage for the recuperation level are predetermined for a predetermined time period for the generator (4) for a “very powerful” (BZ1) state of charge (step S3-1*) and a temperature above the first temperature threshold value (Ts1) (step S3-0) and below a second temperature threshold value (Ts2) (step S3-1*), and
in step S4-3, the nominal value of the charging voltage is predetermined for the normal charging level for an unlimited time for the generator (4) for a “very powerful” (BZ1) state of charge and a temperature above the second temperature threshold value (Ts2) (step S3-3*).

12. The method as claimed in claim 11, characterized in that the first temperature threshold value (Ts1) is 0° C., and the second temperature threshold value (Ts2) is 25° C.

13. An apparatus for battery state identification for a motor vehicle, having:
a device (8) for measurement of a voltage of a motor vehicle battery (5) during the starting process of a motor vehicle over a predetermined time period,
a device (7) for determination of a minimum level of the motor vehicle battery (5) during the predetermined time period of the measurement process,
a device (7) for assessment of a state of charge of the motor vehicle battery (5) on the basis of the determined minimum voltage level, and
a device (7) for controlling a generator (4) as a function of the assessment of the state of charge of the motor vehicle battery (5) in such a way that an adequate supply is ensured for the vehicle power supply system and adequate charging of the motor vehicle battery (5) is ensured, with the fuel consumption and the emissions being optimized at the same time.

14. The apparatus as claimed in claim 13, characterized in that a display device is provided, on which the state of charge is displayed to the vehicle user (as determined by the device (7), for assessment of the state of charge of the motor vehicle battery (5)) in different colors for each state of charge.

15. The apparatus as claimed in claim 13, characterized in that
the device (7) for controlling the generator (4)
predetermines a nominal value of the charging voltage for a normal charging level for an unlimited time for the generator (4) when the state of charge is “restricted power” (BZ3),
predetermines a nominal value of the charging voltage for engine load reduction, followed by the nominal value of the charging voltage for the normal charging level for a predetermined time period for the generator (4) for a “powerful” (BZ2) state of charge,
predetermines the nominal value of the charging voltage for the value for engine load reduction, followed by a reduced vehicle power supply system level and then a recuperation level over a predetermined time period for the generator (4) for a “very powerful” (BZ1) state of charge.

16. The apparatus as claimed in claim 13, characterized in that
in addition, a device (9) is provided for measurement of the ambient temperature, whose measurement result is taken into account by the device (7) for controlling the generator (4), in addition to the result of the assessment of the state of charge.

17. The apparatus as claimed in claim 16, characterized in that the device (7) for controlling the generator
predetermines a nominal value of the charging voltage for the normal charging level for an unlimited time, irrespective of the temperature, for the generator irrespective of the assessed state of charge for a temperature below a first temperature threshold value (Ts1) and for a “restricted power” (BZ3) state of charge,
predetermines a nominal value of the charging voltage for engine load reduction, followed by the nominal value of the charging voltage for the normal charge level for a predetermined time period for the generator for a “powerful” (BZ2) state of charge and a temperature above the first temperature threshold value (Ts1),
predetermines the nominal value of the charging voltage for engine load reduction over a predetermined time period, then a nominal value of the charging voltage for a reduced vehicle power supply system level, followed by a nominal value of the charging voltage for the recuperation level for the generator for a “very powerful” state of charge (BZ1) and a temperature above the first temperature threshold value (Ts1) and below a second temperature threshold value (Ts2),
predetermines the nominal value of the charging voltage for the normal charging level for an unlimited time for the generator for a “very powerful” (BZ1) state of charge and a temperature above the second temperature threshold value (Ts2).
